(19) United States
(12) Patent Application Publication
(10) Pub. No.: US 2012/0328906 A1
(43) Pub. Date: Dec. 27, 2012

(54) METHOD FOR MANUFACTURING GRAPHENE, TRANSPARENT ELECTRODE AND ACTIVE LAYER COMPRISING THE SAME, AND DISPLAY, ELECTRONIC DEVICE, OPTOELECTRONIC DEVICE, BATTERY, SOLAR CELL, AND DYE-SENSITIZED SOLAR CELL INCLUDING THE ELECTRODE AND THE ACTIVE LAYER

(75) Inventors: Soon-Yong KWON, Ulsan (KR); Kibog PARK, ULSAN (KR); Euijoon YOON, Seoul (KR); Jin-Sung KWAK, Busan (KR)

(73) Assignee: UNIST Academy-Industry Research Corporation, Ulsan (KR)

(21) Appl. No.: 13/604,100

(22) Filed: Sep. 5, 2012

Related U.S. Application Data
(63) Continuation of application No. PCT/KR2011/001092, filed on Feb. 18, 2011.

(30) Foreign Application Priority Data
Mar. 9, 2010 (KR) 10-2010-0020990
Dec. 13, 2010 (KR) 10-2010-0126995

(51) Int. Cl. B05D 5/12; B32B 9/04; C01B 31/00; B82Y 40/00; B82Y 30/00

(52) U.S. Cl. 428/688; 427/122; 423/448; 977/742; 977/842

(57) ABSTRACT

Disclosed is a method of manufacturing graphene, a transparent electrode and an active layer including the graphene, and a display, an electronic device, an optoelectronic device, a solar cell, and a dye-sensitized solar cell including the transparent electrode and the active layer. The method of manufacturing graphene includes: (a) preparing a subject substrate; (b) forming a metal thin film on the subject substrate and heat-treating the metal thin film to increase the grain size of the metal thin film; (c) supplying a carbon source material on the metal thin film; (d) heating the supplied carbon source material, the subject substrate, and the metal thin film; (e) diffusing carbon atoms generated from the heated carbon source material due to thermal decomposition into the metal thin film; and (f) forming graphene on the subject substrate by the carbon atoms diffused through the metal thin film.

### CROSS-REFERENCE TO RELATED APPLICATION

This is a continuation of international application no. PCT/KR2011/001092 filed on Feb. 18, 2011, which claims priority to and the benefit of Korean Patent Application No. 10-2010-0020990 filed in the Korean Intellectual Property Office on Mar. 9, 2010 and Korean Patent Application No. 10-2010-0126995 filed in the Korean Intellectual Property Office on Dec. 13, 2010, the entire contents of which are incorporated herein by reference.

### BACKGROUND OF THE INVENTION

(a) Field of the Invention

The present invention relates to a method of manufacturing graphene, a transparent electrode and an active layer including the same, and a display, an electronic device, an optoelectronic device, a battery, a solar cell, and a dye-sensitized solar cell including the electrode and/or the active layer.

(b) Description of the Related Art

In general, since various devices such as a display, a light emitting diode, a solar cell, and the like transmit light to display an image or to produce electric power, they necessarily require a transparent electrode transmitting light. The current transparent electrode may most widely include indium tin oxide (ITO) thin film.

However, the cost of ITO increases as more indium is consumed and indium becomes scarcer. Further, a transparent electrode using ITO is known to have chemical and electrical characteristic defects. Accordingly, active attempts to develop an alternative electrode material that can replace the ITO are being undertaken.

A semiconductor layer using amorphous silicon or polysilicon has recently been developed for use in a thin film transistor (TFT) for electric devices.

When the semiconductor layer is formed of amorphous silicon, the semiconductor layer may exhibit low mobility. The use of such a low mobility layer in electric devices for an excellent characteristic may be difficult.

Silicon has carrier mobility of about 1000 cm²/Vs at room temperature.

Polysilicon may be used as the semiconductor layer to provide high mobility, but the threshold voltage of the TFT may not be uniform.

Additionally, leakage current may occur in the amorphous silicon or polysilicon layer when light, e.g., light from a backlight unit, is incident thereon.

Accordingly, a new material needs to be developed to fabricate faster and better electronic devices.

### SUMMARY OF THE INVENTION

An exemplary embodiment of the present invention provides a method of effectively manufacturing graphene.

Another embodiment of the present invention provides a transparent electrode including the graphene and having improved chemical, optical, and electrical characteristics.

Yet another embodiment of the present invention provides an active layer for an organic/inorganic electronic device, which includes the graphene and has improved physical and electrical characteristics.

Still another embodiment of the present invention provides a display, an organic/inorganic optoelectronic/electronic device, a battery, and a solar cell or a dye-sensitized solar cell including the transparent electrode and/or the active layer.

According to one aspect of the present invention, a method of manufacturing graphene is provided that includes: (a) preparing a subject substrate; (b) forming a metal thin film on the subject substrate and heat-treating the metal thin film to increase the grain size of the metal thin film; (c) supplying a carbon source material on the metal thin film; (d) heating the supplied carbon source material, the subject substrate, and the metal thin film; (e) diffusing carbon atoms generated from the heated carbon source material due to thermal decomposition into the metal thin film; and (f) forming graphene on the subject substrate by the diffused carbon atoms through the metal thin film. The metal thin film may include at least one metal selected from the group consisting of Ni, Co, Fe, Pt, Au, Al, Cr, Cu, Mg, Mn, Mo, Rh, Si, Ta, Ti, W, U, V, Zr, Zn, Sr, Y, Nb, Tc, Ru, Pd, Ag, Cd, In, Re, Os, Ir, and Pb.

The carbon source material may be a vapor, a liquid, or has a solid phase, or a combination thereof.

The carbon source material is a vapor, and the heating (d) may be performed within a temperature ranging from 300 to 1400° C.

The carbon source material is a vapor, and the heating (d) may be maintained for 10 seconds to 24 hours.

The carbon source material is a vapor, and the heating (d) may be performed at a speed ranging from 0.1° C./sec to 500° C./sec.

The carbon source material is a liquid or has a solid phase, and the heating (d) may be performed within a temperature ranging from room temperature to 1000° C.

The carbon source material is a liquid or has a solid phase, and the heating (d) may be maintained for 10 seconds to 10 hours.

The carbon source material is a liquid or has a solid phase, and the heating (d) may be performed at a speed ranging from 0.1° C./sec to 100° C./sec.

The method may further include forming a graphene sheet using the graphene prepared in the step (f).

The metal thin film may be 1 nm to 10 μm thick.

The step (b) may include forming a metal thin film on a subject substrate and heat-treating the subject substrate to naturally form a self-assembled pattern.

According to another aspect of the present invention, a method of manufacturing graphene is provided that includes: (a) preparing a subject substrate; (b) forming a metal thin film on the subject substrate and heat-treating the metal thin film to increase the grain size of the metal thin film; (c) heating the subject substrate and the metal thin film; (d) supplying a carbon source material on the heated metal thin film; (e) diffusing carbon atoms generated from the supplied carbon source material due to thermal decomposition into the metal thin film; and (f) forming graphene on the subject substrate by the diffused carbon atoms through the metal thin film.

The metal thin film may include at least one metal selected from the group consisting of Ni, Co, Fe, Pt, Au, Al, Cr, Cu, Mg, Mn, Mo, Rh, Si, Ta, Ti, W, U, V, Zr, Zn, Sr, Y, Nb, Tc, Ru, Pd, Ag, Cd, In, Re, Os, Ir, and Pb.

The carbon source material may be a vapor, a liquid, or have a solid phase, or a combination thereof.

The heating (c) is performed within a temperature ranging from 400° C. to 1200° C.

The heating (c) may be maintained for 10 seconds to 24 hours.

The heating (c) may be performed at a speed ranging from 0.1° C./sec to 300° C./sec.

The method may further include forming a graphene sheet using the graphene formed in the step (f).

The metal thin film may be 1 nm to 10 μl thick.

The step (b) may include forming a metal thin film on the subject substrate and heat-treating the subject substrate to form a self-assembled pattern.

According to another aspect of the present invention, a transparent electrode including the graphene prepared in the aforementioned method is provided.

According to yet another aspect of the present invention, an active layer including the graphene prepared in the aforementioned method is provided.

According to still another aspect of the present invention, a display including the transparent electrode is provided.

According to still another aspect of the present invention, an electronic device including the active layer is provided.

The display may be a liquid crystal display, an electronic paper display, or an optoelectronic device.

The electronic device may be a transistor, a sensor, or an organic/inorganic semiconductor device.

According to still another aspect of the present invention, an optoelectronic device including: an anode; a hole transport layer (HTL); an emission layer; an electron transport layer (ETL); and a cathode is provided. The anode or the cathode may be the transparent electrode.

The optoelectronic device may further include an electron injection layer (EIL) and a hole injection layer (HIL).

According to still another aspect of the present invention, a battery including the transparent electrode is provided.

According to still another aspect of the present invention, a solar cell including the transparent electrode is provided.

According to still another aspect of the present invention, a sensor including the active layer is provided.

According to still another aspect of the present invention, the active layer is the aforementioned active layer in a solar cell including lower and upper electrode layers laminated on a substrate and at least one active layer between the lower and upper electrode layers.

According to still another aspect of the present invention, a dye-sensitized solar cell is provided that includes a semiconductor electrode, an electrolyte layer, and an opposed electrode. The semiconductor electrode includes a transparent electrode and a photoabsorption layer. The photoabsorption layer includes a nanoparticle oxide and a dye. The transparent electrode and the opposed electrode may be the aforementioned transparent electrode.

The graphene may be prepared directly on any substrate over large area at low temperatures and may be promising for applications as transparent electrode and active layer.

In addition, the graphene may be easily patterned with desired geometries at particular locations by using a pre-patterned metal thin film via a self-assembly or a conventional patterning method.

The graphene may be used to fabricate a display, an optoelectronic/electronic device, a battery, and a solar cell having excellent chemical, optical, and electrical characteristics, and to provide a transistor, a sensor, and an organic/inorganic semiconductor device having excellent physical and electrical characteristics.

### BRIEF DESCRIPTION OF THE DRAWINGS

FIG. 1 provides a flowchart showing a method of manufacturing graphene according to one embodiment of the present invention.

FIG. 2 provides a flowchart showing a method of manufacturing graphene according to another embodiment of the present invention.

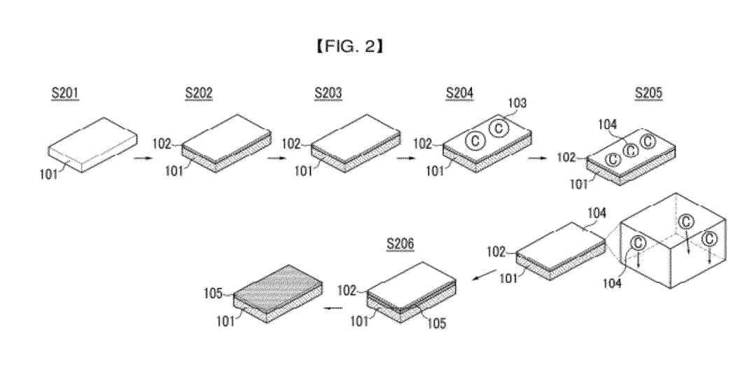

FIG. 3 shows a SEM image of a nickel thin film deposited according to Example 1.

FIG. 4 shows a SEM image of the nickel thin film after heat treatment in Example 1.

FIG. 5 shows a SEM image of a graphene prepared according to Example 1.

FIG. 6 is a SEM image of a graphene prepared according to Example 2.

FIG. 7 provides sheet resistance data of a graphene prepared according to Example 3.

FIG. 8 shows a change in average grain size of a nickel thin film depending on heat-treatment time.

FIG. 9 is a cross-sectional SEM image of a poly[methylmethacrylate] layer prepared according to Example 4.

FIG. 10 shows a SEM image of a graphene prepared according to Example 4.

FIG. 11 provides thickness data of the graphene films according to Examples 4 to 7.

FIG. 12 provides transmittance data of a graphene prepared according to Example b.

### DETAILED DESCRIPTION

Exemplary embodiments of the present disclosure will hereinafter be described in detail. However, these embodiments are only exemplary, and the present invention is not limited thereto.

In this specification, a term “graphene sheet” indicates that graphene having a polycyclic aromatic molecule formed by a plurality of carbon atoms connected by a covalent bond is formed into a sheet. The carbon atoms connected by the covalent bond forms a six-membered ring as a basic repeating unit, but may further include a five-membered ring and/or a seven-membered ring.”

Accordingly, the graphene sheet seems to be a single layer of carbon atoms having a covalent bond (in general, a sp² bond). The sheet may have various structures. These structures may vary depending on the amount of 5-membered rings and/or 7-membered rings included in the graphene. The graphene sheet may have the aforementioned single graphene layer, but a multi-layer formed by laminating several single layers together can also be formed. It may have a thickness of 100 nm at most. In general, the graphene may be saturated with hydrogen atoms at the side end.

The graphene sheet has a characteristic that an electron flows as if it has zero mass. In other words, electrons flow at the speed of light in a vacuum. The graphene sheet has a high mobility ranging from about 10,000 to 100,000 cm²/Vs.

In addition, graphene sheets have surface contact and thus, very low contact resistance compared with point contact of carbon nanotubes. The graphene sheets may be prepared to be very thin and thus surface roughness is prevented. Furthermore, it may be simply separated from inexpensive graphite.

In particular, since a graphene sheet with a predetermined thickness may have various electrical characteristics depending on crystal direction, a user may realize electrical characteristics in a desired direction. Accordingly, a device may be easily designed.

Hereinafter, referring to drawings, a method of manufacturing graphene according to one embodiment of the present invention is illustrated.

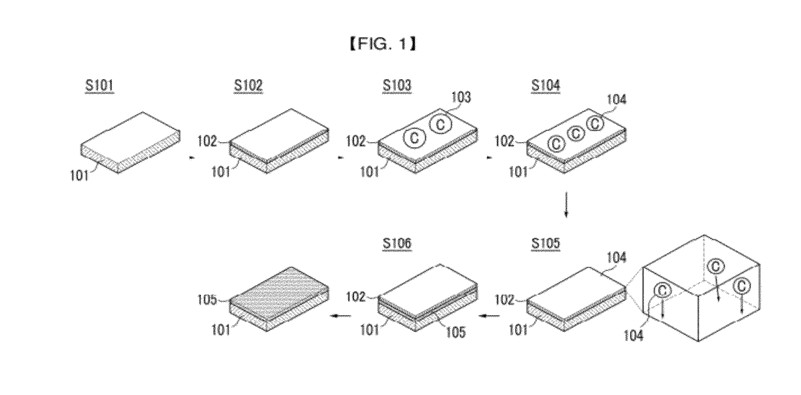

FIG. 1 provides a flowchart showing a method of manufacturing graphene 105 according to one embodiment of the present invention.

According to one embodiment of the present invention, a method of manufacturing graphene 105 may include (a) preparing a subject substrate 101 (S101), (b) forming a metal thin film 102 on the subject substrate 101 and heat-treating the metal thin film 102 to increase grain size of the metal thin film 102 (S102), (c) supplying a carbon source material 103 on the metal thin film 102 (S103), (d) heating the supplied carbon source material 103, the subject substrate 101, and the metal thin film 102 (S104), (e) diffusing carbon atoms 104 generated from the heated carbon source material 103 due to thermal decomposition into the metal thin film 102 (S105), and (f) forming graphene 105 on the subject substrate 101 by the diffused carbon atoms 104 through the metal thin film 102 (S106).

The subject substrate 101 may include: a group IV semiconductor substrate such as Si, Ge, SiGe, and the like; a group III-V compound semiconductor substrate such as GaN, AlN, GaAs, AlAs, GaP, and the like; a group II-VI compound semiconductor substrate such as ZnS, ZnSe, and the like; an oxide semiconductor substrate such as ZnO, MgO, sapphire, and the like; an insulator substrate such as SiO₂, glass, quartz, and the like; or an organic material substrate such as a polymer, a liquid crystal, and the like. In general, the subject substrate 101 may include a substrate used for a display, an optoelectronic/electronic device, a battery, or a solar cell, and for a transistor, a sensor or an organic/inorganic semiconductor device may be used, but is not limited thereto.

The metal thin film 102 is formed on the subject substrate 101 (S102). When the carbon source material 103 is supplied on the metal thin film 102 later, the metal thin film 102 may have a catalyst effect so that the carbon source material 103 may be decomposed at a relatively low temperature. Carbon atoms from the decomposed carbon source material 103 exist on the surface of the metal thin film 102. When the carbon source material 103 is a vapor, a hydrogen group left after the decomposition may be vaporized in the form of hydrogen gas.

The metal thin film 102 may include at least one metal selected from the group consisting of Ni, Co, Fe, Pt, Au, Al, Cr, Cu, Mg, Mn, Mo, Rh, Si, Ta, Ti, W, U, V, Zr, Zn, Sr, Y, Nb, Tc, Ru, Pd, Ag, Cd, In, Re, Os, Ir and Pb.

The metal thin film 102 may be formed by a vapor deposition method such as an evaporation method, sputtering, a chemical vapor deposition (CVD) method, and the like.

The metal thin film is deposited under various conditions depending on the subject substrate.

First, when a metal thin film is deposited on an inorganic material substrate including a semiconductor substrate such as Si, GaAs, and the like or an insulator substrate such as SiO₂ and the like, it may be heated at a temperature ranging from room temperature to 1200° C., or in particular, from room temperature to 1000° C.

In this application, the room temperature is a common term that can either denote a certain temperature to which humans are accustomed or a specific temperature. Accordingly, the room temperature may be changed by season, weather, location or interior condition.

The heating may be performed for 1 second to 10 hours, 1 second to 30 minutes, or in particular, for 3 seconds to 10 minutes.

The heating may be maintained for 10 seconds to 10 hours, 30 seconds to 3 hours, or in particular, for 30 seconds to 90 minutes.

The heating may be performed at a speed of 0.1° C./sec to 100° C./sec, 0.3° C./sec to 30° C./sec, or in particular, 0.5° C./sec to 10° C./sec.

In addition, when a metal thin film is deposited on an organic material substrate such as a polymer, a liquid crystal, and the like, the heating may be performed within a temperature ranging from room temperature to 400° C., room temperature to 200° C., or in particular, room temperature to 150° C.

The heating may be performed for 1 second to 2 hours, 1 second to 20 minutes, or in particular, 3 seconds to 10 minutes.

The heating may be maintained for 10 seconds to 10 hours, 30 seconds to 3 hours, or in particular, 30 minutes to 90 minutes.

The heating speed may be performed at a speed ranging from 0.1° C./sec to 100° C./sec, 0.3° C./sec to 30° C./sec, or in particular, 0.5° C./sec to 10° C./sec.

The grain size of the metal thin film 102 may depend on types of the lower subject substrate 101 and the deposition conditions.

When the subject substrate 101 has the high crystallinity as a semiconductor substrate such as Si, GaAs, and the like, it may have a grain size ranging from several tens of nanometers (at room temperature) to several micrometers (at 1000° C.) depending on deposition temperature. When the lower subject substrate 101 is made of an amorphous inorganic material such as SiO₂, it may have a grain size ranging from several nm (at room temperature) to several hundreds of nm (at 1000° C.). When the lower subject substrate 101 is an organic material such as a polymer and a liquid crystal, it may have a grain size ranging from several nm (at room temperature) to several hundreds of nm (at 400° C.).

The as-deposited metal thin film 102 has a relatively small grain size, however, the grain may be oriented along one direction and have an increased size by heat-treating the deposited metal thin film 102 under a particular atmosphere such as ultra-high vacuum, a hydrogen atmosphere, or the like.

Herein, the heat treatment may be performed under various conditions depending on kinds of a subject substrate 101.

First, when the subject substrate 101 is a semiconductor substrate made of an inorganic material such as Si, GaAs, and the like, or an insulator substrate such as one made of SiO₂ or the like, the heating may be in a temperature ranging from 400° C. to 1400° C., 400° C. to 1200° C., or in particular, 600° C. to 1200° C.

The heating may be performed for 1 second to 10 hours, 1 second to 30 minutes, or in particular, 3 seconds to 10 minutes.

The heating may be maintained for 10 seconds to 10 hours, 30 seconds to 1 hour, or in particular, 1 minute to 20 minutes.

The heating speed may be in a range from 0.1° C./sec to 100° C./sec, 0.3° C./sec to 30° C./sec, or in particular, 0.5° C./sec to 10° C./sec.

The heating may be performed under vacuum, in air, or by inflowing an inert gas such as Ar and N₂, a vapor such as H₂, O₂, and the like, and a mixture thereof. The H₂ inflow may be appropriate to increase grain size.

When the subject substrate 101 is made of an organic material such as a polymer, a liquid crystal, and the like, the heating may be performed at a temperature ranging from 30° C. to 400° C., 30° C. to 300° C., or in particular, 50° C. to 200° C.

The heating may be performed for 1 second to 10 hours, 1 second to 30 minutes, or in particular, 3 seconds to 5 minutes.

The heating may be maintained for 10 seconds to 10 hours, 30 seconds to 1 hour, or in particular, 1 minute to 20 minutes.

The heating speed may be in a range from 0.1° C./sec to 100° C./sec, 0.3° C./sec to 30° C./sec, or in particular, 0.5° C./sec to 10° C./sec.

The heating environment may include vacuum, air, or inflow of an inert gas such as Ar and N₂, and a vapor such as H₂, O₂, and the like. The H₂ inflow may be useful to increase the grain size.

When a metal thin film 102 is generally heat-treated in this way, the average grain size of the metal thin film 102 may be twice to 1000 times. The metal thin film 102 may have a thickness ranging from 1 nm to 10 μm, 10 nm to 1 μm, or in particular, 30 nm to 500 nm. When it has a thickness within the range, graphene 105 can be easily formed by diffused carbon atoms 104 through the metal thin film 102.

The carbon source material 103 supplied in the step (c) (S103) may have a vapor-phase, a liquid-phase, a solid-phase, or a combination thereof. In particular, the vapor carbon source material 103 may include methane, ethane, propane, butane, isobutane, pentane, isopentane, neopentane, hexane, heptane, octane, nonane, decane, methene, ethene, propene, butene, pentene, hexene, heptene, octene, nonene, decene, ethyne, propyne, butyne, pentyne, hexyne, heptyne, octyne, nonyne, decyne, cyclomethane, cycloethine, cyclobutane, methyl cyclopropane, cyclopentane, methylcyclobutane, ethylcyclopropane, cyclohexane, methylcyclopentane, ethylcyclobutane, propylcyclopropane, cycloheptane, methylcyclohexane, cyclooctane, cyclononane, cyclodecane, methylene, ethediene, allene, butadiene, pentadiene, isopyrene, hexadiene, heptadiene, octadiene, nonadiene, decadiene, and the like. The solid-phased carbon source material 103 may be highly-oriented pyrolytic graphite, graphite, amorphous carbon, diamond, spin-coated carbon films, and the like. The liquid carbon source material 103 may be a gel prepared by breaking a solid-phase carbon source such as graphite, a highly-oriented pyrolytic graphite (HOPG) substrate, amorphous carbon, and the like into pieces and dissolving it in various alcohol solvents such as acetone, methanol, ethanol, pentanol, ethylene glycol, glycerin, and the like. The solid-phase carbon material may have a size ranging from 1 nm to 100 cm, 1 nm to 1 mm, or in particular, 1 nm to 100 μm.

The step (d) (S104) may be performed at a temperature ranging from room temperature to 1000° C., 30° C. to 600° C., or in particular, 35° C. to 300° C. This temperature range is remarkably lower than the temperature for preparing a graphene 105 thin film in a chemical vapor deposition (CVD) method. The heating process within the temperature range may cost less than a conventional process and prevent transformation of a subject substrate 101 originated from a high temperature process.

In addition, the heating may be performed for 1 second to 10 hours, 1 second to 30 minutes, or in particular, 2 seconds to 10 minutes. The heating may be maintained for 10 seconds to 10 hours, 30 seconds to 1 hour, or in particular, 1 minute to 20 minutes.

The heating speed may be within a range from 0.1° C./sec to 100° C./sec, 0.3° C./sec to 30° C./sec, or in particular, 0.5° C./sec to 10° C./sec.

The heating temperature may be more appropriate for a liquid or a solid-phase carbon source material 103.

For example, when the carbon source material 103 is a vapor, it may be heated under the following temperature condition.

The heating temperature may range from 300 to 1400° C., 500 to 1200° C., or in particular, 500 to 1000° C.

In addition, the heating may be performed for 1 second to 24 hours, 1 second to 3 hours, or in particular, 2 seconds to 1 hour. The heating may be maintained for 10 seconds to 24 hours, 30 seconds to 1 hour, or in particular, 1 minute to 30 minutes.

The heating speed may be within a range from 0.1° C./sec to 500° C./sec, 0.3° C./sec to 300° C./sec, or in particular, 0.3° C./sec to 100° C./sec.

The heating temperature and time may be adjusted to stably manufacture a desired graphene 105. In addition, the temperature and time may be changed to control the thickness of the graphene 105.

Next, pyrolyzed carbon atoms 104 on the metal thin film 102 may be spontaneously diffused into the metal thin film 102 (S105) due to the carbon concentration gradient.

For metal-carbon system, the carbon atoms 104 may have solubility of several percent in metal and thus may be dissolved in one subsurface of the metal thin film 102. The dissolved carbon atoms 104 in one subsurface of the metal thin film 102 may be spontaneously diffused into the other subsurface of metal thin film 102 due to the concentration gradient. When the carbon atoms 104 have predetermined solubility near the other subsurface of the metal thin film 102, graphene 105 may be segregated or precipitated on the other surface of the metal thin film 102. Accordingly, the graphene 105 is formed between the subject substrate 101 and the metal thin film 102.

On the other hand, when the metal thin film 102 is near the carbon source material 103, the metal thin film 102 may play a role of a catalyst for effectively decomposing the carbon source material 103.

As a result, the decomposed carbon atoms 104 may be spontaneously diffused due to a concentration gradient along dislocation core, the grain boundary, and the like, which are line or planar defects inside the polycrystalline metal thin film 102.

The carbon atoms 104 reaching the subject substrate 101 by spontaneous diffusion process may diffuse along the interface between the subject substrate 101 and the metal thin film 102 and form the graphene 105.

The carbon atoms 104 may have different diffusion mechanisms described above depending on the kinds of the aforementioned carbon source material and heating conditions such as heating temperature and time.

The heating may be regulated regarding temperature, time, and speed to control the number of layers of graphene 105. Accordingly, the graphene 105 may be a multi-sheet.

The graphene sheet 105 may have a thickness ranging from about 0.1 nm to about 100 nm, preferably about 0.1 to 10 nm, and more preferably about 0.1 to 5 nm. When it has a thickness of 100 nm or more, it may not be graphene 105 but may be graphite, which is beyond the range of the present invention.

The metal thin film 102 may be removed by an organic solvent and the like. In this process, a remaining carbon source material 103 on the metal thin film 102 may be removed. The organic solvent may include hydrochloric acid, nitric acid, sulfuric acid, iron chloride, pentane, cyclopentane, hexane, cyclohexane, benzene, toluene, 1,4-dioxane, methylene chloride (CHCl₃), diethylether, dichloromethane, tetrahydrofuran, ethylacetate, acetone, dimethyl formamide, acetonitrile, dimethylsulfoxide, formic acid, n-butanol, isopropanol, m-propanol, ethanol, methanol, acetic acid, distilled water, and the like.

When the metal thin film 102 is patterned before supplying the carbon source material 103, a graphene sheet 105 may be prepared to have desired geometries at particular locations. The patterning may include any common method used in a related art and thus will not be illustrated in detail.

In addition, before supplying the carbon source material 103, the metal thin film 102 may be naturally patterned due to heat treatment. In general, when a thinly-deposited metal thin film 102 is heat-treated at a high temperature, it may have a structural transformation from a two-dimensional thin film to a three-dimensional thin film due to active movement of metal atoms, which may be used to selectively deposit graphene 105 on a subject substrate 101.

According to another embodiment of the present invention, a method of manufacturing graphene 105 is provided, which includes (a) preparing a subject substrate 101 (S201), (b) forming a metal thin film 102 on the subject substrate and heat-treating the metal thin film to increase grain size of the metal thin film (S202), (c) heating the subject substrate and the metal thin film (S203), (d) supplying a carbon source material 103 on the heated metal thin film 102 (S204), (e) diffusing carbon atoms 104 generated from the carbon source material 103 due to thermal decomposition into the metal thin film 102 (S205), and (f) forming graphene 105 on the subject substrate 101 by the diffused carbon atoms 104 through the metal thin film 102 (S206).

The heating step (c) (S203) may be performed at a temperature ranging from 400 to 1200° C., 500 to 1000° C., or in particular, 500 to 900° C. The temperature is remarkably lower than the temperature for synthesizing a graphene thin film 105 in a chemical vapor deposition (CVD) method. The heating within the temperature range may cost less than a conventional heating process, and may also prevent transformation of the subject substrate 101.

In addition, the heating time may range from about 10 seconds to 1 hour, or in particular, about 1 minute to 20 minutes. The heating may be maintained for 10 seconds to 24 hours, 30 seconds to 2 hours, or in particular, 1 minute to 1 hour.

The heating speed may range from 0.1° C./sec to 300° C./sec, or in particular, 0.3° C./sec to 100° C./sec.

The heating temperature and time may be controlled to stably manufacture the graphene 105. In addition, the temperature and time may be changed to control the thickness of the graphene 105.

The mentioned heating conditions may be appropriate when the carbon source material 103 is a vapor.

The other components are the same and thus will not be illustrated.

Furthermore, the (b) and (c) steps may be simultaneously performed.

The method of manufacturing graphene may provide large-area graphene films ranging over from several mm to several cm at low temperatures by using a liquid and/or solid-phased carbon material.

In addition, the graphene may be directly deposited on any substrate such as a semiconductor, an insulator, and an organic material substrates without transfer process.

In particular, when the graphene prepared by a method of manufacturing graphene according to one embodiment of the present invention is used as an active layer of a conventional Si-based TFT, all the equipment for a conventional Si process considering temperature sensitivity may be used.

Since the graphene can be directly grown on any substrate at low temperatures without transfer process, it may bring about huge economic profits in mass production and yield improvement in quality. In particular, since graphene may be easily wrinkled, torn, and the like as it becomes larger, direct growth of graphene on desired substrate without transfer process may be necessary for mass production.

In addition, a carbon source material used in the method of manufacturing graphene costs very much less than a conventional carbonized gas with high purity.

According to another embodiment of the present invention, a transparent electrode including the graphene 105 prepared in the aforementioned method is provided.

When the graphene 105 sheet is used as a transparent electrode, the transparent electrode may have excellent electrical characteristics, that is, high conductivity, low contact resistance, and the like. Since the graphene 105 sheet is very thin and flexible, it can be formed into a flexible transparent electrode.

Accordingly, the transparent electrode including the graphene 105 sheet has excellent conductivity even if formed with a thin thickness, which improves transparency.

The transparent electrode may have transparency ranging from 60 to 99.9% and sheet resistance ranging from 10/sq to 20000/sq.

Since the transparent electrode in a graphene-manufacturing method according to one embodiment of the present invention may be prepared in a simple process, it may be extremely economically and have high conductivity and excellent uniformity. In particular, a large-area graphene 105 sheet can be prepared at low temperatures and the transparency in electrode can be easily controlled by changing the average thickness of graphene 105 sheet. In addition, since the transparent electrode is flexible, it may be applied to any field requiring a flexible transparent electrode.

For example, the transparent electrode including the graphene 105 sheet may be applied to various displays such as a liquid crystal display, an electronic paper display, an organic optoelectronic device, a battery and a solar cell.

When a transparent electrode is used for the display as aforementioned, the display may be freely folded and thus be more convenient. A solar cell including the transparent electrode may have various reflective structures according to the direction of light and thus may efficiently use the light, improving photoefficiency.

When a transparent electrode including a graphene 105 sheet according to one embodiment of the present invention is used to various devices, it may be desirable to control the average thickness of a graphene 105 sheet considering its transparency. For example, the transparent electrode may have a thickness ranging from 0.1 to 100 nm. When it has a thickness of more that 100 nm, it may have deteriorated transparency and thus poor photoefficiency. When it has a thickness of less than 0.1 nm, it may not desirable since the graphene 105 sheet shows excessively low sheet resistance and non-uniformity.

The solar cell including a transparent electrode made of a graphene 105 sheet according to one embodiment of the present invention may include a dye-sensitized solar cell. The dye-sensitized solar cell may include a semiconductor electrode, an electrolyte layer, and an opposed electrode. The semiconductor electrode may include a conductive transparent substrate and a photoabsorption layer and may be prepared by coating the colloid solution of a nanoparticle oxide on a conductive glass substrate, heating it at a high temperature in an electric furnace, and causing a dye to be adsorbed therein.

The conductive transparent substrate may include a transparent electrode made of a graphene 105 sheet according to one embodiment of the present invention. The transparent electrode may be prepared by directly forming the graphene 105 sheet on a transparent substrate. The transparent substrate may include a transparent polymer material or a glass substrate such as polyethylene terephthalate, a polycarbonate, a polyimide, or polyethylene naphthalate. The same may be applied in an opposed electrode.

The dye-sensitized solar cell may have a bending structure, for example, a cylindrical structure. The opposed electrode and the like as well as the transparent electrode may be soft and flexible.

The nanoparticle oxide for the solar cell may be semiconductor particulates, and in particular, an n-type semiconductor with a conductive band that supplies an anode current as a carrier under photo-excitement. Examples of the nanoparticle oxide may include TiO₂, SnO₂, ZnO₂, WO₃, Nb₂O₅, Al₂O₃, MgO, TiSrO₃, and the like, and in particular, an anatase-type TiO₂. The metal oxide may not be limited thereto. In addition, these oxides may be used singularly or as a mixture two or more. This semiconductor particulate may have a larger surface area on which a dye can absorb more light, and thus may have a particle diameter of 20 nm or less.

In addition, the dye may include any dye that is generally used in a solar cell or the photo-battery field, but is preferably a ruthenium complex. The ruthenium complex may include RuL₂(SCN)₂, RuL₂(H₂O)₂, RuL₃, RuL₂, and the like (L in the formula indicates 2,2′-bipyridyl-4,4′-dicarboxylate and the like). However, the dye has no particular limit if it has charge-separating and sensitizing functions, and may include a xanthene-based colorant such as rhodamin B, rose bengal, eosine, erythrosine, and the like, a cyanine-based colorant such as quinocyanine, cryptocyanine, and the like, a basic dye such as phenosafranine, cabri blue, thiosine, methylene blue, and the like, a porphyrin-based compound such as chlorophyl, zinc porphyrin, magnesium porphyrin, and the like, a complex compound such as other azo colorants, a phthalocyanine compound, ruthenium trisbipyridyl, and the like, an anthraquinone-based colorant, a polycyclic quinine-based colorant, and a mixture thereof other than a ruthenium complex.

A photoabsorption layer including the nanoparticle oxide and dye may have a thickness of 15 pm or less, and in particular, ranging from 1 to 15 μm. The reason is that the photoabsorption layer may structurally have large series resistance, thereby deteriorating conversion efficiency. When it has a thickness of 15 μm or less, the layer may maintain its function but has low series resistance and thus prevents deterioration of conversion efficiency.

The dye-sensitized solar cell may include an electrolyte layer such as a liquid electrolyte, an ionic liquid electrolyte, an ionic gel electrolyte, a polymer electrolyte, and a composite thereof. For example, the electrolyte layer may mainly include an electrolyte and with the photoabsorption layer added thereto, or a photoabsorption layer dipped in an electrolyte. The electrolyte may include, for example, an acetonitrile solution of iodine and the like, but is not limited thereto and may include any electrolyte if it has a hole-conducting function.

In addition, the dye-sensitized solar cell may further include a catalyst layer. The catalyst layer promotes oxidation and reduction of a dye-sensitized solar cell. It may include platinum, carbon, graphite, carbon nanotubes, carbon black, a p-type semiconductor, a composite thereof, and the like, and may be disposed between the electrolyte layer and its counter electrode. The catalyst layer has a fine structure to have a larger surface area. For example, platinum may be in a platinum black state, and carbon may be porous. The platinum black state may be formed by treating platinum in an anodic oxidation method, a chloroplatinic acid treatment, and the like. The porous carbon may be acquired by sintering a carbon particulate, baking an organic polymer, and the like.

Since a dye-sensitized solar cell includes a transparent electrode including a graphene 105 sheet with excellent conductivity and flexibility, it may have excellent photo-efficiency and workability.

According to one embodiment of the present invention, the transparent electrode including a graphene 105 sheet may be applied to a display such as an electronic paper display, an optoelectronic device (organic or inorganic), a liquid crystal display, and the like. The organic optoelectronic device may be an active light-emitting display emitting light when electrons and holes are combined in an organic layer if a current flow into a fluorescent or phosphorescent organic compound thin film. In general, an organic optoelectronic device includes an anode on a substrate and a hole transport layer (HTL) on the anode, and an emission layer, an electron transport layer (ETL), and a cathode sequentially formed on the hole transport layer (HTL). The organic optoelectronic device may further include an electron injection layer (EIL) and a hole injection layer (HIL) to facilitate injection of electrons and holes, and additionally a hole blocking layer, a buffer layer, and the like if needed. Since the anode may be a transparent and very conductive material, a transparent electrode including a graphene 105 sheet according to one embodiment of the present may be usefully applied thereto.

The hole transport layer (HTL) may include a common material, and in particular, polytriphenylamine, but is not limited thereto.

The electron transport layer (ETL) may include a common material, and in particular, polyoxadiazole, but is not limited thereto.

A light-emitting material for the emission layer may include a generally-used fluorescent or phosphorescent light-emitting material without limit, but may further include one selected from more than one of a polymer host, a mixture host of a polymer and low molecular host, a low molecular host, and a non-light-emitting polymer matrix. Herein, the polymer host, the low molecular host, and the non-light emitting polymer matrix may include any material used to form an emission layer for an organic electric field light emitting element. Examples of the polymer host may include poly(vinylcarbazole), polyfluorene, poly(p-phenylene vinylene), polythiophene, and the like. Examples of the low molecular host may include CBP (4,4′-N,N′-dicarbazole-biphenyl), 4,4′-bis[9-(3,6-biphenylcarbazolyl)]-1-1,1′-biphenyl{4,4′-bis[9-(3,6-biphenylcarbazolyl)]-1-1,1′-phenyl}, 9,10-bis[(2′,7′-t-butyl)-9′,9″-spirobifluorenyl anthracene], tetrafluorene, and the like. Examples of the non-light emitting polymer matrix may include polymethylmethacrylate, polystyrene, and the like, but are not limited thereto. The aforementioned emission layer may be formed in a vacuum deposit method, a sputtering method, a printing method, a coating method, an Inkjet method, and the like.

According to one embodiment of the present invention, an organic electric field light emitting element may be fabricated without a particular device or method according to a method of fabricating an organic electric field light emitting element using a common light emitting material.

In addition, graphene according to one embodiment of the present invention may be used as an active layer for an electronic device.

The active layer may be used for a solar cell. The solar cell may include at least one active layer between lower and upper electrode layers laminated on a substrate.

Examples of the substrate may be selected from a polyethylene terephthalate substrate, a polyethylene naphthalate substrate, a polyethersulfone substrate, an aromatic polyester substrate, a polyimide substrate, a glass substrate, a quartz substrate, a silicon substrate, a metal substrate, and a gallium arsenide substrate.

The lower electrode layer may include, for example, a graphene sheet, indium tin oxide (ITO), or fluorine tin oxide (FTO).

The electronic device may be a transistor, a sensor, or an organic/inorganic semiconductor device.

A conventional transistor, sensor, and semiconductor device may include a group IV semiconductor heterojunction structure and group III-V and II-VI compound semiconductor heterojunction structures and restricting electron motion in two dimensions by band gap engineering to accomplish high electron mobility ranging from about 100 to 1,000 cm²/Vs. However, since graphene has a high electron mobility ranging from 10,000 to 100,000 cm²/Vs through theoretical calculation, the graphene may have superb physical and electrical characteristics compared with a present electronic device when used as an active layer for a conventional transistor or organic/inorganic semiconductor device. In addition, the sensor may have a superb sensing characteristic compared with a conventional sensor, since it can sense a fine change according to adsorption/desorption of a molecule in one graphene layer.

The graphene according to one embodiment of the present invention may be applied to a battery. For example, the battery can be a lithium secondary battery.

Rechargeable lithium batteries may be classified as lithium ion batteries, lithium ion polymer batteries, and lithium polymer batteries according to the presence of a separator and the kind of electrolyte used in the battery. The rechargeable lithium batteries may have a variety of shapes and sizes, and include cylindrical, prismatic, or coin-type batteries, and may be thin film batteries or may be rather bulky in size.

Structures and fabricating methods for lithium ion batteries pertaining to this disclosure are well known in the art.

The lithium secondary battery includes a negative electrode, a positive electrode, a separator between the negative electrode and the positive electrode, electrolyte, a container of the battery and a sealing member for sealing the container by main components.

The lithium secondary battery is fabricated by laminating the negative electrode, the positive electrode and the separator in order, and then storaging the laminator into the container in a spirally coiled state.

The negative electrode and the positive electrode can comprise a current collector, an active material and a binder.

The current collector may be made of the graphene according to one embodiment of the present invention.

In case of using the electrode made of the graphene for a battery, it can be improved that a rate charateristic, a life-time charateristic of a battery due to the exellent electron mobility of the graphene.

However, the graphene according to one embodiment of the present invention is not limited to the aforementioned use, but may be applied to any field or use requiring graphene characteristics.

Hereinafter, the embodiments are illustrated in more detail with reference to examples. These examples, however, should not in any sense be interpreted as limiting the scope of the present invention.

### Example

### Preparation of Graphene

### Example 1

### Direct Growth of Graphene on a SiO₂/Si Substrate

A liquid carbon source material according to one embodiment of the present invention was used to directly grow graphene on a SiO₂/Si substrate. The SiO₂ was a 300 nm-thick layer and was deposited on a Si substrate in a conventional thermal growth method.

The surface of the SiO₂/Si substrate was cleaned. Then, a 100 nm-thick nickel thin film was deposited on the SiO₂/Si substrate using an electron beam evaporator. The SiO₂/Si substrate was maintained at 400° C. during the nickel deposition.

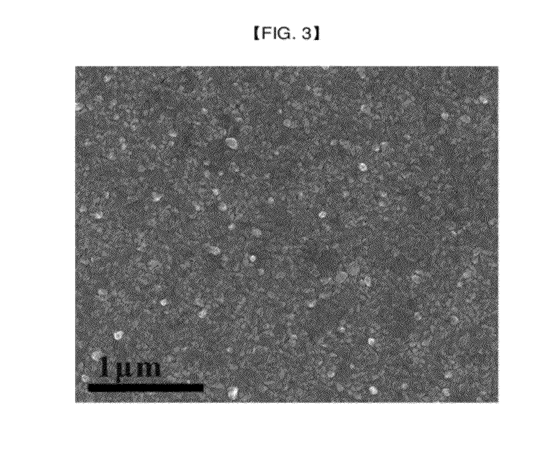

FIG. 3 provides a SEM image of the deposited nickel thin film.

The SEM image shows that the nickel thin film was polycrystalline. It had grains with an average size of about 100 nm.

The nickel thin film was heat-treated to improve the orientation and to increase the average grain size. The heat treatment was performed in a high-vacuum chamber. The chamber was under a hydrogen atmosphere using highly pure (99.9999%) hydrogen gas. When the nickel thin film was heat-treated at 1000° C. under an appropriate hydrogen atmosphere, most of the grains therein were about 10 μm in diameter and oriented to (111).

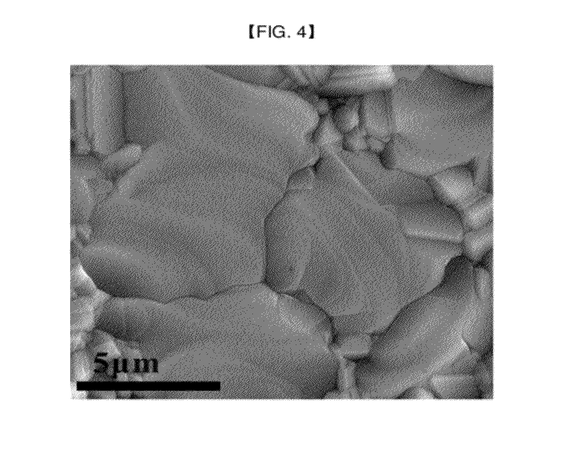

FIG. 4 provides a SEM image of the nickel thin film after the heat treatment.

A graphite powder was used for a carbon source material. The graphite powder was made by Sigma-Aldrich Co. (Product No. 496596, Batch No. MKBB1941) and had an average diameter of about 40 μm or less. The graphite powder was mixed with ethanol, preparing a slush. The slush was put on the nickel/SiO₂/Si, dried at an appropriate temperature, and fixed with a jig made of a special material.

The specimen fabricated in the above method was heated in an electric furnace so that the dissociated carbon source material might be spontaneously diffused through the nickel thin film.

The heating was maintained at 465° C. The temperature was increased within 10 minutes under an argon atmosphere. The temperature was maintained for 5 minutes.

Next, the nickel thin film was etched to reveal the graphene formed at the interface between the nickel thin film and SiO₂. An FeCl₃ aqueous solution was used for an etching solution. The nickel thin film was etched using 1M of the FeCl₃ aqueous solution for 30 minutes. As a result, high quality graphene was formed on a SiO₂/Si substrate over large area.

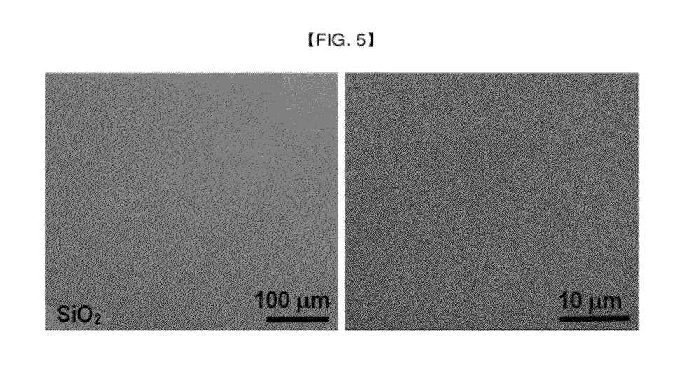

FIG. 5 provides SEM images of the graphene. The graphene was uniformly formed.

### Example 2

Graphene was formed according to the same method as Example 1, except that heating temperature was 160° C. after putting a carbon source material onto a nickel thin film.

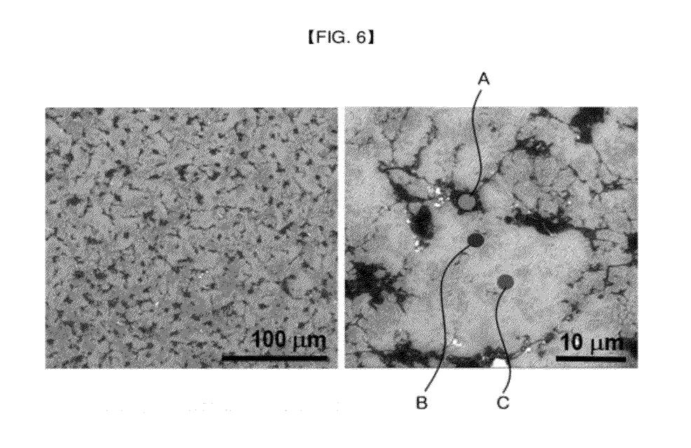

FIG. 6 provides SEM images of the graphene according to Example 2. As shown in FIG. 6, the graphene according to Example 2 had a large grain with average size ranging from several μm to tens of μm. The SEM images show clear brightness contrast depending on the thickness. The lightest image indicates a monolayer graphene C, the light image indicates a bilayer graphene B, and the darkest image indicates multi-layered graphene A.

In addition, as shown in FIG. 6, the graphene according to Example 2 was formed at a low temperature and thus had no creases due to the difference in thermal expansion coefficients between the graphene and an underlying substrate. In general, the crease might deteriorate physical properties of the graphene.

### Example 3

Graphene was formed according to the same method as Example 1, except that heating temperature and time were 60° C. and 10 minutes, respectively, after putting a carbon source material onto a nickel thin film.

### Example a

Graphene was formed according to the same method as Example 1, except that the carbon-Ni/substrate couple was kept at room temperature for 30 minutes after putting a carbon source material onto a nickel thin film.

### Example 4

### Formation of Graphene on a Poly[Methyl Methacrylate] Substrate (Hereinafter Referred to as “PMMA”)

A PMMA raw material in the form of powder was mixed with chlorobenzene as a solvent in a ratio of 1:0.2 (15 wt %) between PMMA and chlorobenzene. The mixture was deposited on a silicon substrate in a sol-gel method.

Specifically, the mixture was spin-coated on a silicon substrate with a size of about 1 cm² at a speed of 3000 RPM for 45 seconds and then heated at 70° C. for 15 minutes to remove impurities and moisture.

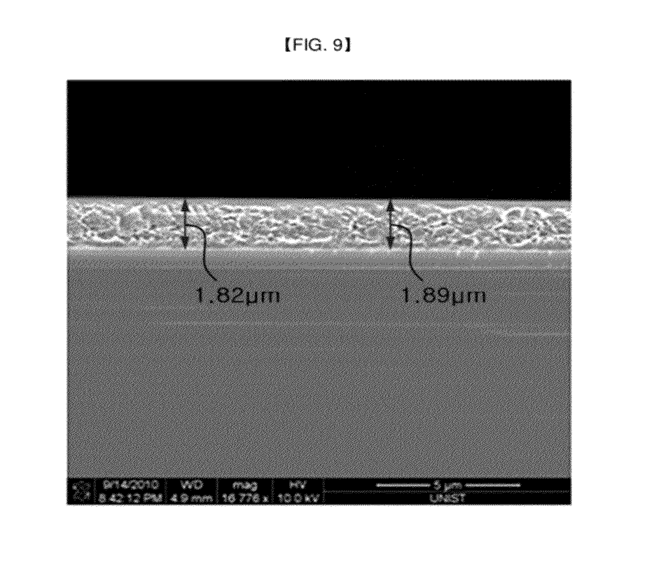

FIG. 9 provides a cross-sectional SEM image of the PMMA layer on a silicon substrate.

Next, a 100 nm-thick nickel thin film was deposited using an electron beam evaporator. Since an organic material such as PMMA and the like had a melting point of 200° C. or lower, the substrate was at room temperature when nickel was deposited.

The crystallinity of nickel thin film deposited on the PMMA at room temperature was examined with XRD and the XRD analysis shows that the nickel thin film is polycrystalline with grains having crystallographic directions of (111) and (200), which have a volume ratio of about 8 to 1, respectively. The average grain size was about 40 to 50 nm. Since the PMMA was weak against heat, the nickel thin film was not heat-treated after the deposition.

Then, the graphite slush was put on the nickel/PMMA and the substrate was fixed with a jig according to the same method as Example 1. This specimen was heated in an electric furnace so that the dissociated carbon source material might be spontaneously diffused through the nickel thin film.

The heat treatment was performed at 60° C. under an argon atmosphere. The temperature was increased within 5 minutes. The temperature was maintained for 10 minutes.

After the heat treatment to diffuse the carbon source material, the nickel thin film was etched to reveal the graphene formed at the interface between the nickel thin film and PMMA. The etchant was a FeCl₃ aqueous solution. 1M of the FeCl₃ aqueous solution was used to etch the nickel for 30 minutes. As a result, the graphene was identified all over the area of the PMMA.

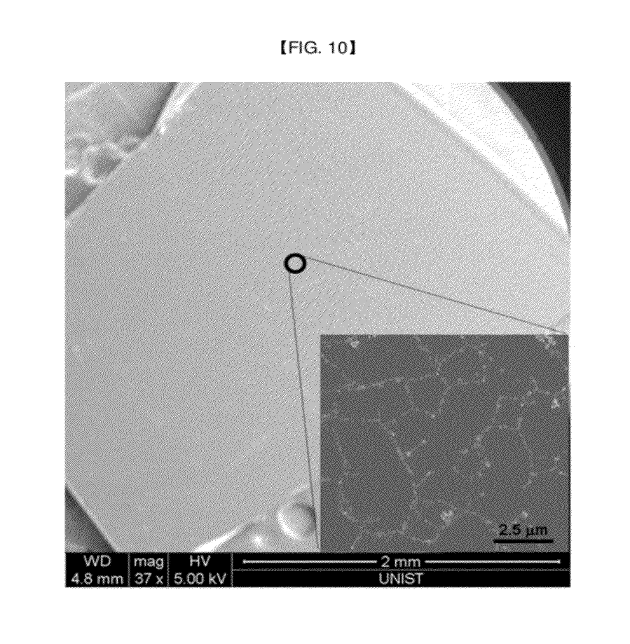

FIG. 10 provides a SEM image of the graphene according to Example 4. The graphene was identified to be uniform.

### Example 5

Graphene was formed according to the same method as Example 4, except that heating temperature was 40° C. after putting a carbon source material onto a nickel thin film.

### Example 6

Graphene was formed according to the same method as Example 4, except that heating temperature was 150° C. after putting a carbon source material onto a nickel thin film.

### Example 7

Graphene was formed according to the same method as Example 4, except that heating temperature and time were 150° C. and 30 minutes, respectively, after putting a carbon source material onto a nickel thin film.

### Example 8

### Formation of Graphene on Polydimethylsiloxane (Hereinafter Referred to as “PDMS”)

Graphene was prepared according to the same method as Example 4, except for using PDMS instead of PMMA. However, a PDMS thin film was formed in the following method.

Since the PDMS with molecular weight (162.38) of a high density had strong durability, it might just be mixed with a hardener (PDMS kit B) to cure a thick PDMS layer without a sol-gel method.

The PDMS A and the hardener (PDMS kit B) might be mixed in a ratio of 10:1 or 7:3 at most for crosslinking. Two materials with high viscosity in a gel were mixed and post-processed for curing. Since the PDMS had flexibility, it might be attached on a silicon substrate for the post process.

The following process is the same as Example 4 and will not be illustrated in this specification.

### Example b

### Formation of Graphene on a Glass Substrate

Graphene was prepared according to the same method as Example 4, except for using a glass substrate instead of PMMA.

### Experimental Example

### Characteristic Evaluation of Graphene

Evaluation of Electrical Characteristic

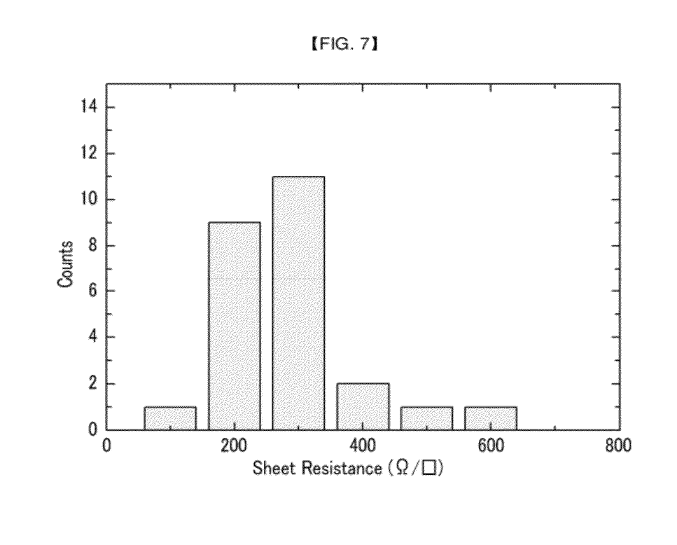

The graphene according to Example 3 was patterned to be 100 μm×100 μm and measured in a van der Pauw method. As a result, the graphene was identified to have average sheet resistance of about 274Ω/□. The result is provided in FIG. 7.

Compared with sheet resistance (approximately −1000Ω/□) of graphene formed at a high temperature in a CVD method, the graphene according to Example 3 had remarkably small sheet resistance and thus excellent electrical characteristics.

In other words, one embodiment of the present invention may provide a method of manufacturing graphene at a temperature of 300° C. or lower, in particular, at room temperature of approximately 40° C., and might directly grow graphene on an inorganic and organic material substrate over large area without transfer process. The graphene grown in this method had excellent characteristics compared with graphene grown in a CVD method.

Evaluation of Optical Characteristic

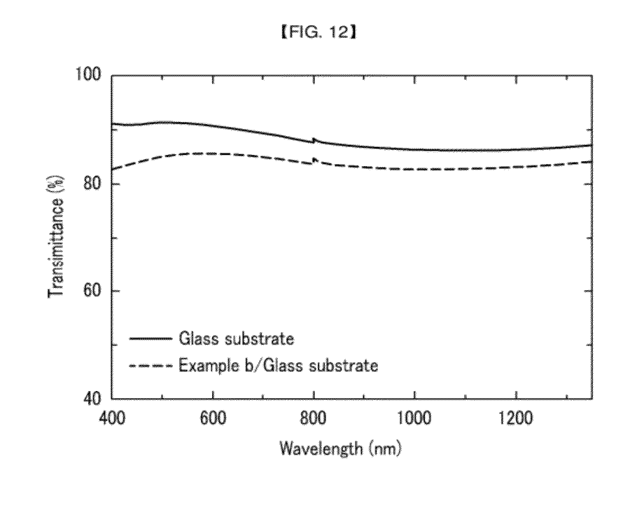

Graphene according to Example b was evaluated regarding transparency over the entire visible range of wavelengths using a UV-VIS spectrometer. As shown in FIG. 12, graphene grown on a glass substrate had high transmittance of more than 80% in a visible range and the transmittance reduction due to graphene is in the range of about 2 to 7% compared with the transmittance of the glass substrate itself.

On the other hand, considering a 2.3% absorption of incident white light in an individual graphene layer, the graphene used herein might have three layers or less.

Accordingly, the transmittance of graphene according to Example b had a much higher value than the one prepared in a chemical vapor deposition (CVD) method, showing excellent optical characteristics of graphene grown in this method.

Evaluation of Heat Treatment Condition to Increase Average Grain Size of a Metal Thin Film

A metal thin film was heat-treated to adjust its orientation and to increase a grain size, increasing the size of a graphene grain, and thereby improving graphene characteristics.

Herein, the heat treatment might be performed within a high temperature range where a subject substrate is not damaged. The Ni/SiO₂/Si according to Example 1 was heat-treated at 1000° C. in a high vacuum (10⁻⁹ Torr) chamber, acquiring a nickel thin film having an average size of about 5 μm with (111) orientation.

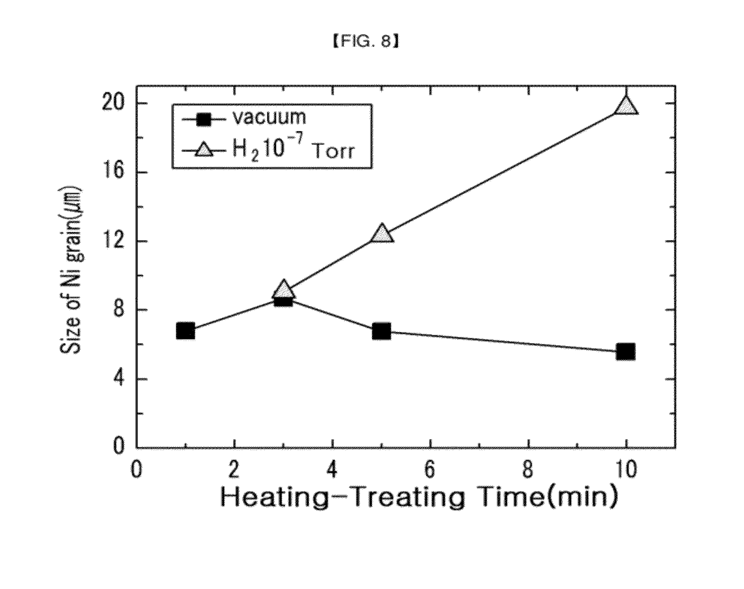

FIG. 8 provides a graph showing a change in the average grain size of a nickel thin film depending on the heat treatment time under a hydrogen atmosphere.

When hydrogen flowed during the heat treatment, nickel grains might have a size that is increased by several times. Accordingly, when the heat treatment was performed for 10 minutes while hydrogen flowed at 10⁻⁷ Torr, a nickel thin film having a grain with an average size of about 20 μm with (111) orientation was formed.

When hydrogen flowed over an appropriate amount during the heat treatment, a nickel thin film might have a larger grain size. However, when a carbon source material was diffused later through the nickel thin film, the carbon source material might react with hydrogen remaining in the nickel thin film and vaporize in the form of hydrocarbon gas, forming no graphene on a SiO₂/Si side.

Thickness Measurement of the Graphene According to Example 4 Using an Atomic Force Microscope (AFM)

Since the graphene according to Example 4 grew on an organic material substrate over large area, it was difficult to measure the thickness. Thus, the graphene grown on an organic material substrate was transferred to a SiO₂/Si substrate.

After the transfer process, its thickness was measured using an AFM.

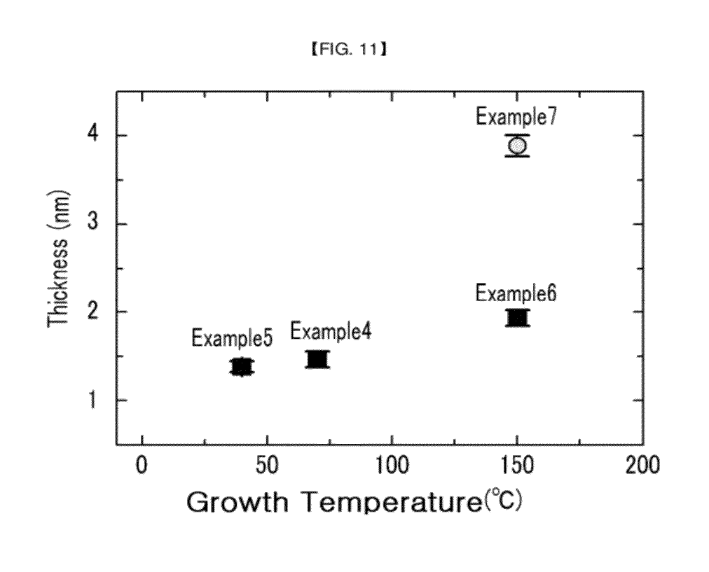

FIG. 11 shows thickness measurements of the graphenes according to Examples 4 to 7. The graphene layers had a thickness ranging from about 1 nm to 2 nm, that is, from 1 layer to 3 layers considering the existence of a spacer layer between graphene and SiO₂, i.e. H₂O, which was very thin.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Therefore, the aforementioned embodiments should be understood to be exemplary but not limiting in any way.

### DESCRIPTION OF SYMBOLS

101: subject substrate
102: metal thin film
103: carbon source material
104: carbon atom
105: graphene

What is claimed is:

1. A method of manufacturing graphene:
(a) preparing a subject substrate;
(b) forming a metal thin film on the subject substrate and heat-treating the metal thin film to increase the grain size of the metal thin film;
(c) supplying a carbon source material on the metal thin film;
(d) heating the supplied carbon source material, the subject substrate, and the metal thin film;
(e) diffusing carbon atoms generated from the heated carbon source material due to thermal decomposition into the metal thin film; and
(f) forming graphene on the subject substrate by the carbon atoms diffused through the metal thin film.

2. The method of manufacturing graphene of claim 1, wherein the metal thin film comprises at least one metal selected from the group consisting of Ni, Co, Fe, Pt, Au, Al, Cr, Cu, Mg, Mn, Mo, Rh, Si, Ta, Ti, W, U, V, Zr, Zn, Sr, Y, Nb, Tc, Ru, Pd, Ag, Cd, In, Re, Os, Ir and Pb.

3. The method of claim 1, wherein the carbon source material is a vapor, a liquid, or has a solid phase, or combination thereof.

4. The method of claim 1, wherein the carbon source material is a vapor, and the heating (d) is performed in a range from 300 to 1400° C.

5. The method of claim 1, wherein the carbon source material is a vapor, and the heating (d) is maintained for 10 seconds to 24 hours.

6. The method of claim 1, wherein the carbon source material is a vapor, and the heating (d) is performed at a speed ranging from 0.1° C./sec to 500° C./sec.

7. The method of claim 1, wherein the carbon source material is a liquid or has a solid phase, and the heating (d) is performed in a range from a room temperature to 1000° C.

8. The method of claim 1, wherein the carbon source material is a liquid or has a solid phase, and the heating (d) is maintained for 10 seconds to 10 hours.

9. The method of claim 1, wherein the carbon source material is a liquid or has a solid phase, and the heating (d) is performed at a speed ranging from 0.1° C./sec to 100° C./sec.

10. The method of claim 1, wherein the metal thin film has a thickness ranging from 1 nm to 10 μm.

11. The method of claim 1, wherein the step (b) comprises forming a metal thin film on the subject substrate and heat-treating the subject substrate to naturally form a pattern.

12. A method of manufacturing graphene, comprising:
(a) preparing a subject substrate;
(b) forming a metal thin film on the subject substrate and heat-treating the metal thin film to increase the grain size of the metal thin film;
(c) heating the subject substrate and the metal thin film;
(d) supplying a carbon source material on the heated metal thin film;
(e) diffusing carbon atoms generated from the supplied carbon source material due to thermal decomposition into the metal thin film; and
(f) forming graphene on the subject substrate by the carbon atoms diffused through the metal thin film.

13. The method of manufacturing grapheme of claim 12, wherein the metal thin film comprises at least one metal selected from the group consisting of Ni, Co, Fe, Pt, Au, Al, Cr, Cu, Mg, Mn, Mo, Rh, Si, Ta, Ti, W, U, V, Zr, Zn, Sr, Y, Nb, Tc, Ru, Pd, Ag, Cd, In, Re, Os, Ir and Pb.

14. The method of claim 12, wherein the heating (c) is performed in a temperature range from 400° C. to 1200° C.

15. The method of claim 12, wherein the heating (c) is maintained for 10 seconds to 24 hours.

16. The method of claim 12, wherein the heating (c) is performed at a speed ranging from 0.1° C./sec to 300° C./sec.

17. The method of claim 12, wherein the metal thin film has a thickness ranging from 1 nm to 10 μm.

18. The method of claim 12, wherein the step (b) comprises forming a metal thin film on the subject substrate and heat-treating the subject substrate formed with the metal thin film to naturally form a pattern.

19. A transparent electrode comprising the graphene prepared according to claim 1.

20. An active layer comprising the graphene prepared according to claim 1.
